(19) United States
(12) Patent Application Publication
(10) Pub. No.: US 2009/0146010 A1
(43) Pub. Date: Jun. 11, 2009

(54) AERIAL TRANSPORT SYSTEM

(76) Inventor: Nehemia Cohen, Hoshaya (IL)

Correspondence Address: D. Kligler I.P. Services LTD, P.O. Box 25, Zippori, 17910, IL

(21) Appl. No.: 12/300,126

(22) PCT Filed: May 10, 2007
(86) PCT No.: PCT/IL07/00577

§ 371 Date: Nov. 10, 2008

(30) Foreign Application Priority Data
May 11, 2006 (IL) 175593
Jan. 8, 2007 (IL) 180591

(51) Int. Cl. B64D 1/08; G06F 17/00

(52) U.S. Cl. 244/137.1; 701/3

(57) ABSTRACT

Apparatus (20) for aerial transport includes a cabin (24) for containing a load and one or more cables (30), attached so as to suspend the cabin below a hovering aircraft (22). An elevator mechanism (32) is coupled to raise and lower the cabin on the one or more cables. A control unit (56) is coupled to receive an input from at least one cabin sensor (38, 40, 48, 50, 60, 62) that is indicative of the disposition of the cabin relative to the terrestrial target (26), and to control the elevator mechanism responsively to the input so as to bring the cabin into with a predetermined position relative to the terrestrial target while the aircraft is hovering.

### FIELD OF THE INVENTION

The present invention relates generally to aircraft, and specifically to vehicles for use in delivery of people and supplies to and from a hovering aircraft.

### BACKGROUND OF THE INVENTION

Various systems and methods are known in the art for delivery of people and supplies to and from a hovering helicopter, without requiring the helicopter to land. Such systems may comprise a cabin that may be raised and lowered below the helicopter by cable.

For example, U.S. Pat. No. 3,934,847, whose disclosure is incorporated herein by reference, describes a helicopter with a rescue capsule connected to the helicopter by cables and winches. A projecting guide member of the capsule projects through an opening in the floor of the helicopter to correctly align and stabilize the connection between the capsule and helicopter. As another example, U.S. Pat. No. 3,997,135, whose disclosure is incorporated herein by reference, describes a maneuverable vehicle, which is adapted to be suspended from above by a helicopter. The vehicle has a pair of rudders and a propeller, as well as a sliding door to allow ingress and egress.

Some helicopters are equipped with an autopilot and sensing devices that can assist in stable hovering. For example, PCT Patent Publication WO 91/17084, whose disclosure is incorporated herein by reference, describes a system for aiding the pilot of a helicopter in hover flight while carrying a load. The load is supported below the helicopter by a rigid structure, which is provided with tension and inclination sensors. The information provided by the sensors is used in maintaining the helicopter at the proper location above the load.

As another example, PCT Patent Publication WO 2005/078545, whose disclosure is also incorporated herein by reference, describes a method and system for controlling a helicopter position in hover mode. A television camera tracks a surface under the helicopter in order to determine the hovering altitude and/or deviation from a specified altitude. This system may also be used to determine angular data on the basis of helicopter pitch and roll. The picture of the surface may be displayed together with altitude and angular data to assist the pilot in controlling the helicopter.

### SUMMARY OF THE INVENTION

In many situations, a hovering aircraft is required to deliver or pick up a load (personnel and/or supplies) in a location in which the aircraft cannot readily land, due to constraints of space, topography or other hazardous conditions. In such situations, the aircraft may raise or lower the load by cable, but this approach has its own limits and hazards, among them the lack of precise control over the attitude (i.e., angular orientation) of the load and the position onto which it is lowered.

The embodiments of the present invention that are described hereinbelow provide apparatus and methods for aerial transport that increase the accuracy and safety with which loads may be lowered and raised by providing a cabin with an integrated guidance system. The cabin is suspended below the aircraft by one or more cables, with an elevator mechanism for lowering and raising the cabin while the aircraft hovers. One or more thrusters may be fixed to the cabin and operated by the guidance system to maneuver the cabin as it is being lowered or raised. Additionally or alternatively, the guidance system may control movement of the aircraft itself or may provide maneuver instructions to the pilot of the aircraft.

The pilot (or other operator of the apparatus) identifies a terrestrial target to which the cabin is to be lowered. One or more sensors on the cabin and/or on the aircraft measure the disposition (linear displacement and orientation) of the cabin relative to the target. A control unit (which may be located in the cabin or in the aircraft) controls the elevator mechanism and the thrusters automatically, based on input from the sensors, so as to bring the cabin into a predetermined position relative to the terrestrial target while the aircraft hovers above. This predetermined position may be in contact with the target, or it may alternatively be a small distance away.

In some embodiments, the cabin is designed to fit into a recess in the fuselage of the aircraft during flight, thus enhancing stability and aerodynamic properties during flight. Alternatively, in other embodiments, the cabin may be suspended below the aircraft during flight. In these latter embodiments, the sensors and thrusters may be used in stabilizing the cabin during flight, as well as during lowering of the cabin. The principles of the present invention may similarly be applied to slung loads of other types, and not only the dedicated cabins that are described hereinbelow.

There is therefore provided, in accordance with an embodiment of the present invention, apparatus for aerial transport, including:

a cabin for containing a load;

one or more cables, attached so as to suspend the cabin below a hovering aircraft;

an elevator mechanism, which is coupled to raise and lower the cabin on the one or more cables;

at least one cabin sensor; and

a control unit, which is coupled to receive an input from the at least one cabin sensor that is indicative of the disposition of the cabin relative to the terrestrial target, and to control the elevator mechanism responsively to the input so as to bring the cabin into with a predetermined position relative to the terrestrial target while the aircraft is hovering.

In some embodiments, the cabin is shaped and sized so as to fit within a recess in a fuselage of the aircraft, and to be lowered out of the recess on the one or more cables.

In some embodiments, the elevator mechanism includes a winch for extending and retracting the cables. The winch may be fixed to the aircraft or to the cabin. In a disclosed embodiment, the apparatus includes a load sensor, which is coupled to measure a tension in the one or more cables. Additionally or alternatively, the apparatus includes a speed sensor, which is coupled to measure a rate of raising or lowering the cabin by the elevator mechanism.

In some embodiments, the at least one cabin sensor includes an imaging device, which is disposed so as to capture an image of the terrestrial target, and the control unit is configured to process the image so as to determine the disposition of the cabin relative to the terrestrial target. The imaging device may be disposed on the cabin or on the aircraft. The imaging device may include, for example, a radar sensor or an optical sensor. In one embodiment, the apparatus includes one or more optical targets disposed on the cabin, wherein the control unit is configured to determine a location of the one or more optical targets in the image, and to determine a position of the cabin relative to the aircraft based on the determined location.

In other embodiments, the at least one cabin sensor includes an inertial sensor. In one such embodiment, the inertial sensor includes a first inertial sensor fixed to the cabin, and the apparatus includes a second inertial sensor fixed to the aircraft, and the control unit is operative to detect changes in a first reading provided by the first inertial sensor relative to a second reading provided by the second inertial sensor, and to process the detected changes in order to measure a motion of the cabin relative to the aircraft.

Alternatively, the at least one cabin sensor may include a proximity sensor, which is configured to indicate a distance between the cabin and an object adjacent to the cabin.

In other embodiments, the at least one cabin sensor includes at least one satellite-based navigation device. In one such embodiment, the at least one satellite-based navigation device includes a plurality of first satellite-based navigation devices fixed to the cabin at different, respective locations, and the apparatus includes at least one second satellite-based navigation device fixed to the aircraft, and the control unit is coupled to receive and process inputs from the first and second satellite-based navigation devices in order to determine a position and orientation of the cabin relative to the aircraft.

In yet another embodiment, the at least one cabin sensor includes a rangefinder.

In disclosed embodiments, the control unit is configured to control the elevator mechanism responsively to the input so as to bring the cabin into contact with the terrestrial target while the aircraft is hovering.

In one embodiment, the cabin includes two compartments, which are configured to fit on opposite, respective sides of fuselage of the aircraft and which have respective inner doors, which are arranged so as to communicate with aircraft doors on the respective sides of the fuselage.

In some embodiments, the apparatus includes one or more thrusters, which are fixed to the cabin and configured to exert a force in a direction transverse to the one or more cables, so as to maneuver the cabin relative to the aircraft, wherein the control unit is coupled to control the one or more thrusters responsively to the input from the at least one cabin sensor. In one embodiment, the at least one cabin sensor is configured to sense a force exerted on the cabin by a wind, and the control unit is configured to actuate at least one of the thrusters so as to counteract the force.

In another embodiment, the cabin is configured to hang below the aircraft during longitudinal flight of the aircraft, and the one or more thrusters are operative during the longitudinal flight to exert the force so as to stabilize the cabin against lateral movement. Typically, the at least one cabin sensor includes an inertial sensor, which is configured to provide an indication of the lateral movement, and the control unit is configured to operate the one or more thrusters during the longitudinal flight responsively to the indication.

In yet another embodiment, the terrestrial target is located on a vertical surface, and the control unit is configured to cause the elevator mechanism and thrusters to bring the cabin into proximity with the vertical surface without contacting a horizontal surface beneath the vertical surface.

Alternatively, the terrestrial target is located on a horizontal surface, and the control unit is configured to cause the elevator mechanism to lower the cabin onto the terrestrial target while the aircraft hovers above the terrestrial target.

The apparatus may include one or more coupling units, which are attached to the cables so as to absorb changes in tension in the cables.

In a disclosed embodiment, the control unit is located in the aircraft, and the apparatus includes, in the cabin, a wireless communication unit, which is coupled to the at least one cabin sensor and is configured to communicate over a wireless link with the control unit.

There is also provided, in accordance with an embodiment of the present invention, apparatus for aerial transport, including:

an aircraft, which is capable of hovering;

a cabin for containing a load;

one or more cables, attached so as to suspend the cabin below the aircraft while the aircraft hovers;

an elevator mechanism, which is coupled to raise and lower the cabin on the one or more cables;

at least one cabin sensor; and

a control unit, which is coupled to receive an input from the at least one cabin sensor that is indicative of the disposition of the cabin relative to the terrestrial target, and to control the elevator mechanism responsively to the input so as to bring the cabin into contact with the terrestrial target while the aircraft is hovering.

There is additionally provided, in accordance with an embodiment of the present invention, a computer-implemented method for aerial transport, including:

lowering a cabin, for containing a load, from a hovering aircraft toward a terrestrial target using one or more cables attached to the aircraft;

sensing a disposition of the cabin relative to the terrestrial target using at least one cabin sensor;

responsively to an input from the at least one cabin sensor, automatically controlling the lowering of the cabin so as to maneuver the cabin relative to the aircraft and to bring the cabin into a predetermined position relative to the terrestrial target while the aircraft is hovering.

The present invention will be more fully understood from the following detailed description of the embodiments thereof, taken together with the drawings in which:

### BRIEF DESCRIPTION OF THE DRAWINGS

FIGS. 1A-1C are schematic, pictorial illustrations, showing a system for aerial transport, in accordance with an embodiment of the present invention, at three successive stages in lowering a cabin to the ground;

FIGS. 2A and 2B are schematic frontal views of a system for aerial transport, at two successive stages in bringing a cabin into contact with a vertical surface of a structure, in accordance with another embodiment of the present invention;

FIGS. 3-5 are schematic side views of systems for aerial transport, in accordance with alternative embodiments of the present invention; and

FIGS. 6A and 6B are schematic frontal views of a system for aerial transport, in accordance with another embodiment of the present invention.

### DETAILED DESCRIPTION OF EMBODIMENTS

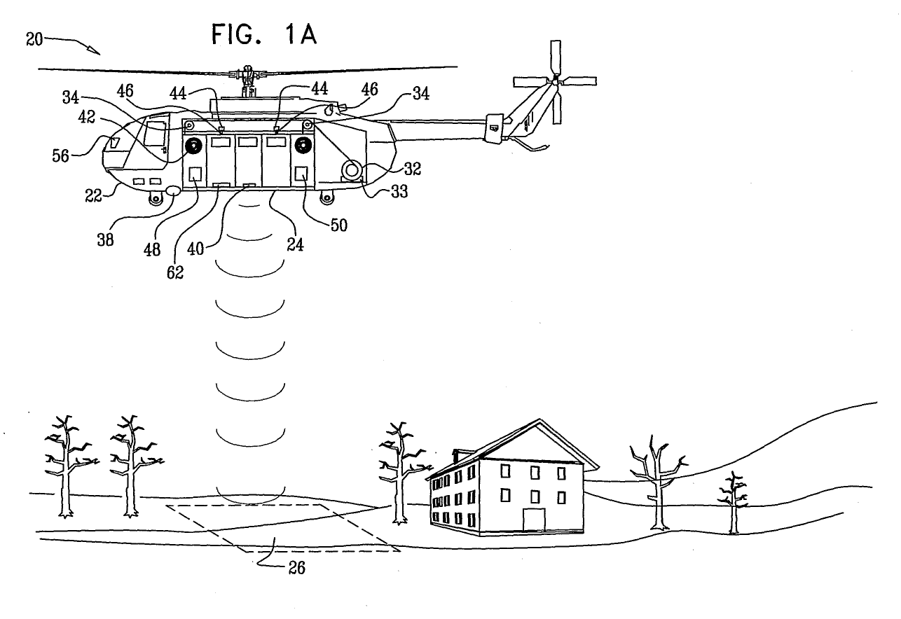

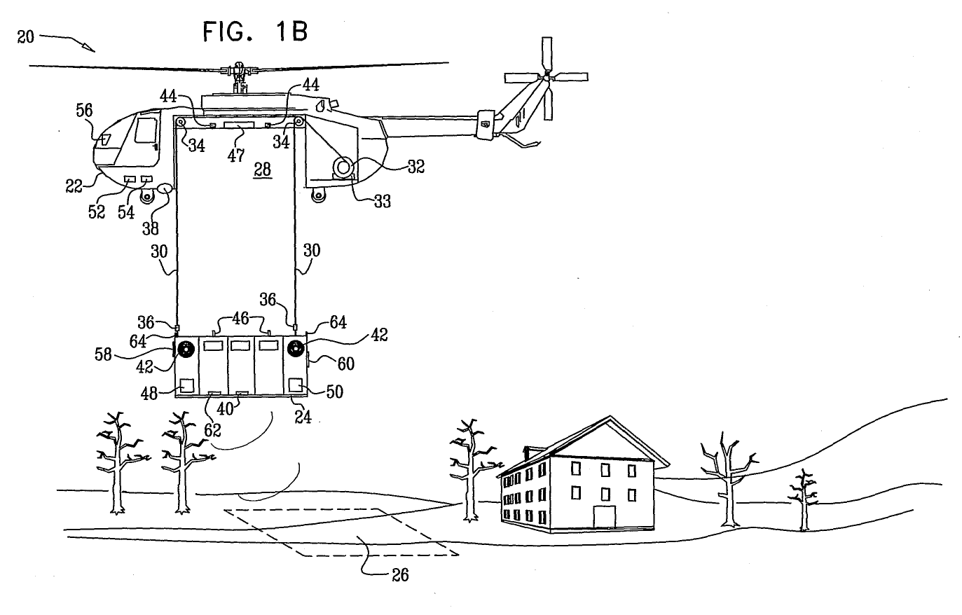

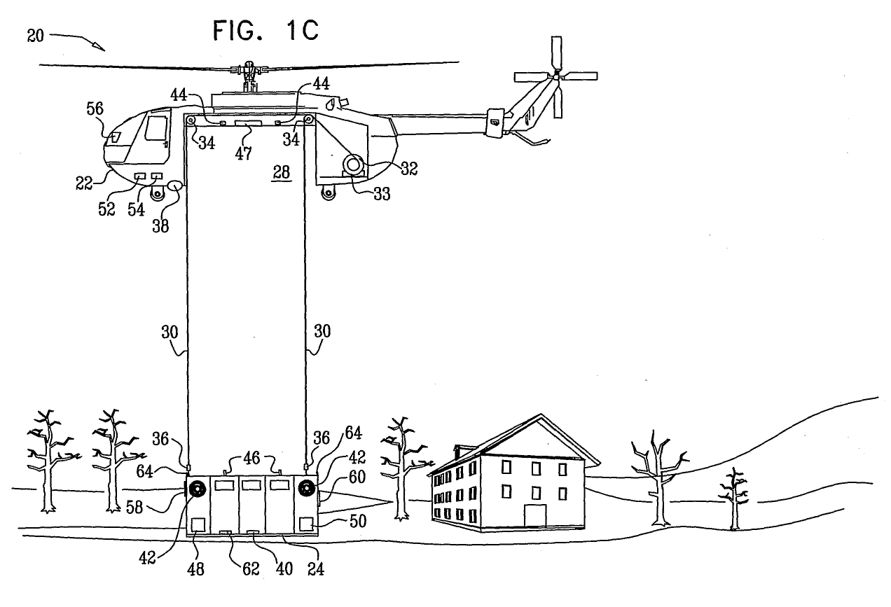

Reference is now made to FIGS. 1A-1C, which are schematic, pictorial illustrations showing a system 20 for aerial transport, in accordance with an embodiment of the present invention. The system comprises a cabin 24, which is suspended below a helicopter 22 and lowered onto a terrestrial target 26 as described hereinbelow. The cabin is sized and shaped so as to fit within a dedicated recess 28 in the fuselage of the helicopter. FIG. 1A shows the cabin retracted and locked within this recess, which holds the cabin securely while the helicopter flies to and from the area of the target. FIG. 1B shows the cabin in the process of being lowered toward the target on cables 30, while FIG. 1C shows the cabin resting on target.

Cabin 24 may be used to lower and raise loads of substantially any sort, including both people and supplies. For reasons of comfort and safety, it is desirable that the cabin be a closed unit, with suitable means for ventilation and a door or doors that open when the cabin reaches the target. Alternatively, the cabin may comprise a platform that is at least partially open. Although the embodiments pictured in the figures show cabins suspended below helicopters, the principles of the present invention may similarly be applied in delivery and pickup of personnel and supplies by other types of aircraft that are capable of hovering, including lighter-than-air vehicles, as well as by remotely-piloted aircraft.

Cabin 24 is suspended from helicopter 22 by cables 30, which are extended and retracted by an elevator mechanism, such as a winch unit 32 with pulleys 34, which are attached to the helicopter. Although two cables and a single winch unit are shown in these figures for the sake of simplicity, in practice, a single cable or three or more cables may be used, and multiple winch units may be used in their deployment. The winch unit typically comprises an elevator sensor package 33, which may comprise, for example, a rotation sensor for measuring the length of cable between the helicopter and the cabin, as well as the speed of extension or retraction of the cables. Additionally or alternatively, package 33 may comprise a load sensor for measuring tension in the cables. Further additionally or alternatively, the pulleys may comprise sensors of these sorts, as well as angle sensors for determining the angle of cables 30 relative to the helicopter. (Generally speaking, it is desirable that the helicopter remain vertically above cabin 24.)

Cables 30 are typically connected to cabin 24 by coupling units 36, which may comprise, for example, suitable springs and dampers to absorb any sudden changes in tension, such as may occur when the cabin touches down on the ground. Coupling units 36 may also comprise sensors, such as load sensors and/or angle sensors, as explained above. The load sensors in this case may comprise load cells, which can indicate not only the magnitude of the force between the cable and the cabin, but also the directional components.

Prior to deployment of cabin 24, the cabin is typically held securely within recess 28, as shown in FIG. 1A, in such a manner as to reduce vibration and other instabilities. For example, the cabin may be held by engagement of prongs 46 in suitable sockets 44. A quick-release clamping mechanism 47 may be used to hold and release the cabin at the appropriate times. The configuration of FIG. 1A is advantageous in maintaining good aerodynamic properties of the helicopter in flight and permitting the helicopter to take off and land with cabin 24 in place (as opposed to slung loads, which must be attached and detached while the helicopter hovers).

In operation, the pilot of helicopter 22 flies over target 26, and actuates a control unit 56 to acquire and lock onto the target. The control unit typically comprises an embedded computer, with a suitable user interface (display and user controls), along with interfaces and drivers for the winch and for the sensors and thrusters that are described hereinbelow. (The design and arrangement of the elements of the control unit will be apparent to those skilled in the art, and they are omitted from the figures for the sake of simplicity.) The control unit is shown in the figures as being located in the cockpit of helicopter 22, but it may alternatively be located in cabin 24. Further alternatively, both the cockpit and cabin may contain control units, which communicate with one another via wireless or wired link and may operate redundantly for enhanced safety and reliability.

Control unit 56 acquires and locks onto target 26 by means of a set of one or more cabin sensors, with which the control unit communicates via wireless or wired connections. (“Wired,” in this context, includes any sort of cable or fiber that may be used to link the control unit with the sensors, including optical fiber.) Various different types of sensors may be used for this purpose, individually or in combination, as described in detail hereinbelow. For example, an imaging sensor 38 on the underside of the helicopter and/or an imaging sensor 40 on the underside of cabin 24 may be used to capture an image of the target, i.e., of the area on the ground onto which the cabin is to be lowered. Any suitable type of imaging sensors may be used for this purpose, including, for example, optical sensors (using visible or infrared light), thermal imaging sensors, radar sensors, and acoustic imaging sensors.

The operator of the cabin (who may be the pilot or another person) observes the image formed by sensor 38 and/or 40 on a display provided by control unit 56, and marks the target location on the image, using a suitable pointing device. Alternatively, the control unit may acquire the target automatically, based on instructions programmed in advance. As another option, ground personnel may mark the landing site using a laser designator, for example, or other marker. Further alternatively or additionally, sensor 40 may also comprise a rangefinder, or else a separate rangefinder may be provided on cabin 24, in order to determine the distance to the target.

In any case, control unit 56 detects and tracks the target location in successive images as cabin 24 is lowered, using techniques of image and signal processing that are known in the art, and thus locks onto the location and provides guidance accordingly. The control unit may guide the cabin autonomously by homing on target 26, with little or no involvement by the operator after the target has been acquired. Alternatively or additionally, the operator may guide the cabin to the target manually, using the controls of control unit 56, with automatic assistance by the control unit and guidance system of cabin 24 in maintaining the stability and proper attitude and position of the cabin.

The guidance may be implemented in various ways. In the embodiment shown in FIGS. 1A-1C, for example, cabin 24 comprises thrusters 42, which may be actuated by control unit 56 to move cabin 24 in a transverse (typically horizontal) direction. The thrusters may comprise any suitable type of propulsion device, such as propellers or jets, which may be driven, for example, by an internal power supply in the cabin or by electrical power conveyed from the helicopter. In some applications, such as firefighting, in which cabin 24 may contain a water source, the jets may emit water, rather than gas. Although two thrusters are shown in the figures, cabin 24 may typically comprise four or more thrusters, pointed in different directions, to facilitate flexible maneuvering of the cabin. Control unit 56 may control the force exerted by each of the thrusters as required for proper guidance of the cabin.

Additionally or alternatively, control unit 56 may control the position of helicopter 22, in order to reduce the energy expended in operation of thrusters 42 while maintaining the proper height, position and attitude. Typically, the helicopter is positioned vertically over cabin 24, which is in turn positioned vertically over target 26. For this purpose, the control unit may either drive the hover position of the helicopter automatically, or it may provide guidance instructions to the pilot. If the control of the helicopter is sufficiently precise, it may be possible to guide the cabin accurately by movement of the helicopter alone, in which case thrusters 42 may be unnecessary.

For accurate lowering of the cabin into tight spaces, however, particularly in windy conditions, it is desirable to use the thrusters in order to control the cabin position more accurately. In such cases, the helicopter may hold a position that is not directly above the target, but rather upwind. As another example, when the cabin is to be lowered toward a hazardous site (such as a burning building), it may be desirable, for safety reasons, for the helicopter to hover a small distance off-target and to use the thrusters to guide the cabin sideways to the target.

In the scenario shown in FIGS. 1A-1C, cabin 24 is lowered onto target 26 using imaging sensor 40. In FIG. 1A, control unit 56 acquires an image of target 26 using sensor 40 and begins to lower the cabin. In the course of lowering the cabin, helicopter 22 drifts longitudinally, as shown in FIG. 1B. The control unit senses that the cabin is off target by processing the images provided by sensor 40. In response to the deviation, the control unit actuates thrusters 42 and/or cues the pilot of the helicopter to shift position so that the cabin lands on target, as shown in FIG. 1C. Once the cabin lands, the cabin doors may be opened for loading and/or unloading. After this operation is completed, the helicopter lifts the cabin back up into recess 28 and flies away. Alternatively, however, cables 30 may be detached from the helicopter, and the cabin left in place on the ground.

Additionally or alternatively, control unit 56 may process images provided by sensor 38. As the cabin is lowered, these images will contain the top of the cabin, so that the control unit will be able to determine the position of the cabin (including attitude and distance below the helicopter) directly from the images. To facilitate detection of cabin position, a number of optical targets 64, such as small beacons of visible or infrared light or, alternatively, passive targets, may be placed at predefined locations on the cabin. The control unit can then determine the cabin position accurately and reliably by finding the locations of targets 64 in the image.

Depending on the location of sensor 38 on helicopter 22, this sensor will be able to capture images that contain both cabin 24 and target 26 over a large part of the range of heights of the cabin above the ground as the cabin is lowered. Thus, control unit 56 may rely on these images alone to guide the cabin to the target. Alternatively, sensor 40 and/or other cabin sensors, as described hereinbelow, may be used to provide additional guidance, particularly in the lower range of heights.

Further alternatively, sensor 40 may be used without sensor 38, but possibly in combination with other cabin sensors. For example, the control unit may use sensor inputs from elevator sensor package 33 and/or coupling units 36 in order to determine the height of cabin 24 (based on the height of the helicopter and the length of cables 30 that has been let out) and tilt angle of the cabin relative to the ground.

As another example, cabin 24 may comprise one or more proximity sensors 60 and 62. Such sensors give an indication of the distance from the cabin to nearby objects, typically by transmitting and receiving acoustic waves, radio waves, or light beams, as is known in the art. Additionally or alternatively, such sensors may issue an alarm when cabin 24 is less than a predefined distance from a nearby object. Sensor 60 may provide an indication to control unit 56 of the distance of the side of the cabin to adjacent objects (such as the trees and house shown in the figures), to aid in collision avoidance. Sensor 62 may provide a reading of the distance of the cabin above the ground, particularly at small distances, where imaging sensors 38 and 40 may be less effective.

As yet another example, a wind sensor 58 may be used to sense the strength and direction of wind blowing against cabin 24. For example, the wind sensor may comprise a pressure sensor or an anemometer. Control unit 56 may then actuate thrusters 42 to counteract the wind force, so that the wind does not blow the cabin off the straight course to target 26.

Other types of cabin sensors, in addition to or instead of imaging sensors 38 and/or 40, may be used in guiding cabin 24 to land on target 26. For example, cabin 24 may comprise a package of one or more inertial guidance sensors 48. These sensors may be used in conjunction with (or independently of) an inertial guidance package 52 in helicopter 22. Sensors 48 may comprise one or more of (1) a gyroscope, (2) an accelerometer, (3) a magnetometer (which serves as a compass), and (4) a tilt-meter (which measures angular deviation relative to the earth's gravitational field). Guidance package 52 may comprise similar sorts of sensors.

Control unit 56 may use the input from inertial guidance sensors 48 to track the motion and attitude of cabin 24, so as to ensure that the cabin is lowered along the proper trajectory, with the proper orientation for safe and smooth landing. For this purpose, sensors 48 may be calibrated relative to package 52 while cabin 24 is held in place in recess 28. Changes in the readings of the cabin sensors relative to the sensors in the helicopter will then be indicative of relative motion between the cabin and the helicopter. This sort of inertial tracking may be used together with or instead of the image-based tracking methods described above.

As another alternative or additional means of tracking, cabin 24 may comprise a satellite-based navigation sensing device 50, such as a Geographical Positioning System (GPS) receiver. If the coordinates of target 26 are known precisely, then device 50 can be used, by itself or together with other sensors, such as those described above, to land the cabin on target. These coordinates may be determined in advance, or they may alternatively be provided by another satellite-based navigation sensing device (not shown in the figures), which is placed on target 26 by a person on the ground.

Optionally, multiple satellite-based navigation sensing devices may be deployed in cabin 24 and/or in helicopter 22. For example, device 50 on the cabin may be used in conjunction with a satellite-based navigation sensing device 54 in helicopter 22 in order check the position of the cabin relative to the helicopter. Additionally or alternatively, two (or more) satellite-based navigation sensing devices may be placed at opposite ends of cabin 24 and/or helicopter 22, and the differences between the respective position readings can provide an indication of the attitude of the cabin and/or helicopter. (A single sensing device with multiple antennas at different locations may similarly be used for this purpose.)

Although FIGS. 1A-1C (as well as the figures that follow) show certain numbers of sensors in certain positions and configurations on cabin 24 and helicopter 22, these numbers, positions and configurations of the sensors were chosen solely for the sake of clarity and simplicity. The types of sensors that are described hereinabove may alternatively be used in different combinations and sub-combinations, as well as in combination with sensors of other types not mentioned above. Other embodiments of the present invention, not shown in the figures, may use larger or smaller numbers of such sensors, in various different positions and configurations, as will be apparent to those skilled in the art,

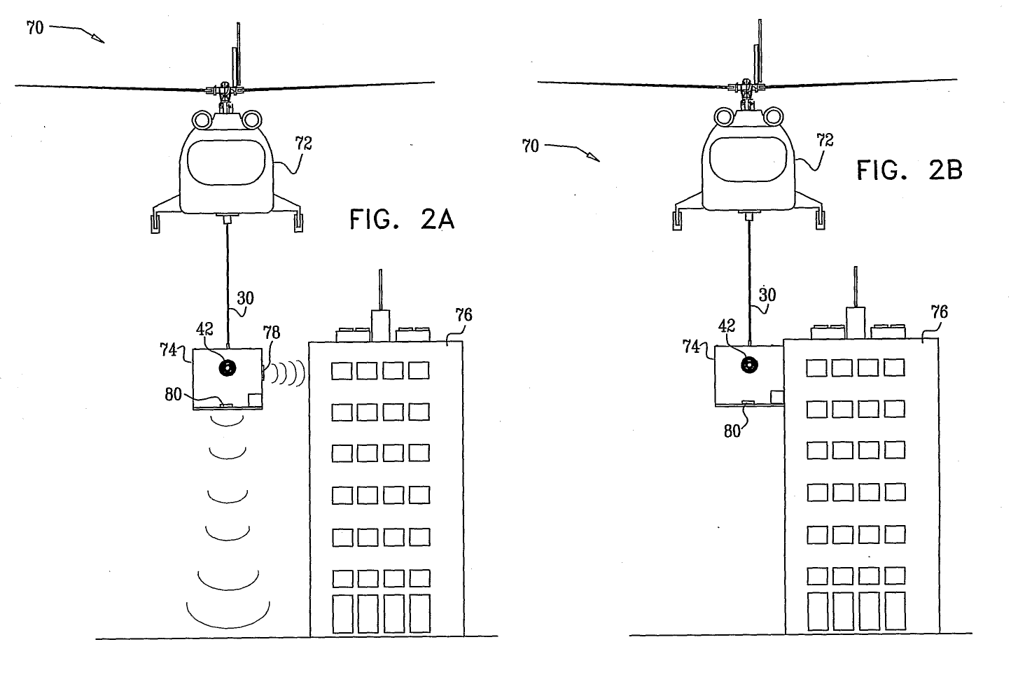

Reference is now made to FIGS. 2A and 2B, which are schematic frontal views of a system 70 for aerial transport, in accordance with another embodiment of the present invention. In this embodiment, the terrestrial target is on a vertical surface, such as a window in the wall of a building 76, rather than on a horizontal surface (the ground) as in the preceding embodiment. System 70 comprises a helicopter 72, which lowers and maneuvers a cabin 74 so that the cabin is in contact with or in close proximity to the target, as shown in FIG. 2B. In this position, it is possible, for example, for people to enter or the building from the cabin through an upper-story window, or to exit in like fashion.

Helicopter 72 and cabin 74 may be equipped with the same sorts of sensors and other devices as helicopter 22 and cabin 24, as described above, but for the sake of simplicity, only a few such sensors and devices are shown in FIGS. 2A and 2B. Cabin 74 is shown to comprise two imaging sensors 78 and 80. Sensor 78 captures an image of the vertical surface that includes the target, and the control unit processes this image in order to acquire and lock onto the target. Optionally, sensor 80 captures images of the ground below, to assist in ensuring that cabin 74 approaches building 76 at the proper location and orientation. Alternatively, other types of sensors may be used for this purpose, as explained above in reference to FIGS. 1A-1C.

In typical operation, the pilot of helicopter 72 approaches building 76 and lowers cabin 74 to a position near the building, as shown in FIG. 2A. Sensor 78 captures an image of the target. The control unit determines how far the cabin must move in order to contact the target. It then gives instructions to the pilot and/or controls the length of cable 30 and/or the operation of thrusters 42 in order to move the cabin into the proper position, as shown in FIG. 2B. As explained above, the helicopter may attempt to hover vertically over the target, as shown in the figure in order to minimize use of the thrusters. Alternatively, the helicopter may hover a small distance off-target (to the left of its position in FIG. 2B, for example), while the thrusters push the cabin laterally toward the target.

Further alternatively, the helicopter and cabin may be controlled so that the cabin is brought into a predetermined position near the target, but not in contact with the target while the helicopter hovers above. This sort of positioning is useful, for example, in firefighting, where it may be desirable to position the cabin very close to a burning building, but not in physical contact with the building.

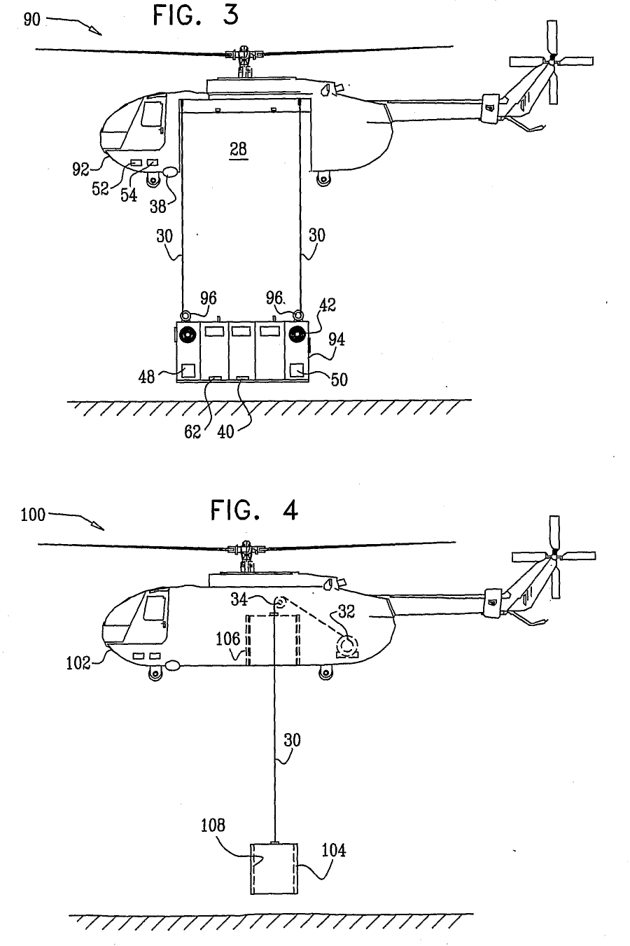

FIG. 3 is a schematic side view of a system 90 for aerial transport, in accordance with an alternative embodiment of the present invention. In this embodiment, a helicopter 92 raises and lowers a cabin 94 on cables 30, using sensors and thrusters in a manner very similar to the embodiment of FIGS. 1A-1C. The key difference here is that the elevator mechanism in system 90, in the form of winches 96, is attached to the cabin, rather than to the helicopter as in the preceding embodiment. (The cables may be attached by springs and dampers, as in coupling units 36 shown in FIGS. 1B and 1C, in order to absorb sudden changes in tension.)

This approach may be advantageous, for example, in retrofitting the cabin to an existing helicopter while saving space in the helicopter and minimizing the changes that must be made in the helicopter itself.

FIG. 4 is a schematic side view of a system 100 for aerial transport, in accordance with another alternative embodiment of the present invention. In this embodiment, a smaller cabin 104 is designed to fit entirely within a suitable space in the fuselage of a helicopter 102 during flight. While the cabin is within the helicopter, safety doors 106 and 108 inside the fuselage and in the cabin may be opened so that people and supplies can move in and out of the cabin. These doors are closed, like elevator doors, before the cabin is lowered out of the helicopter. The cabin is brought into contact with a terrestrial target using sensors, a control unit, and possibly thrusters (not shown in FIG. 4), in the manner described above. This embodiment may provide enhanced safety and ease of installation and deployment of the cabin, although the capacity of the cabin is decreased relative to the preceding embodiments.

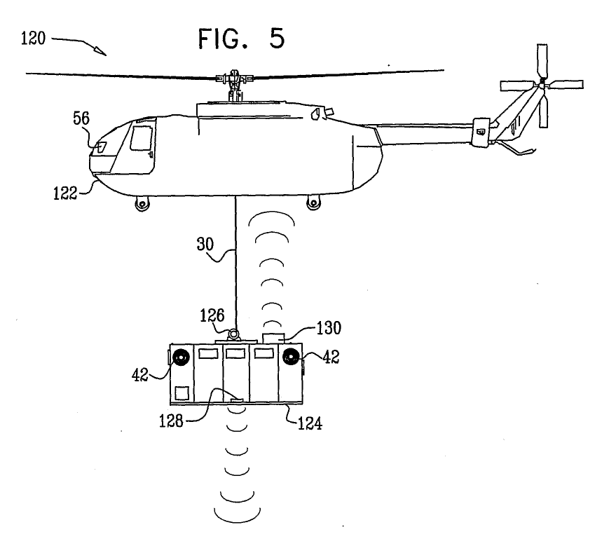

FIG. 5 is a schematic side view of a system 120 for aerial transport, in accordance with still another alternative embodiment of the present invention. In this embodiment, a cabin 124 is carried externally below a helicopter 122. This sort of cabin can thus be retrofitted to an existing helicopter with substantially no mechanical modifications to the helicopter (assuming the helicopter already has a suitable hook to which cable 30 may be attached). Control unit 56 may be installed in the cockpit of the helicopter, as shown in the figure, or alternatively or additionally, some or all of the functions of the control unit may reside in the cabin.

Cabin 124 is a self-contained unit, with a winch 126 for raising and lowering the cabin on cable 30. (As in the preceding embodiments, the cables may be attached by a coupling unit, not shown in this figure, which absorbs changes in tension not only during lowering and raising of the cabin, but also during longitudinal flight of the helicopter.) A lower imaging sensor 128 captures images of the ground, including the target onto which the cabin is to be lowered. An upper imaging sensor 130 captures images of helicopter 122. The cabin may also comprise other sensors, such as a side-viewing imaging sensor (like sensor 78, shown in FIG. 2A but not shown in this figure). The control unit processes the images captured by sensor 128 in order to guide the cabin onto the target, while processing the images captured by sensor 130 in order to verify that the cabin is in the correct attitude and position relative to the helicopter. The control unit operates the thrusters and/or alerts the pilot of helicopter 122 in order to correct any deviation from the correct attitude and target trajectory.

Additionally or alternatively, cabin 124 may comprise other types of sensors for these purposes, as described above. For example, a sensor package 132 may comprise one or more inertial sensors, which may operate independently or in conjunction with an inertial guidance package in helicopter 122 (such as package 52 in FIGS. 1A-1C), in the manner described above. The sensor package may comprise a wireless communication link for communicating with control unit 56 in helicopter 122. In this configuration, the sensor package may also, for example, receive inputs from imaging sensors 128 and 130, as well as from other sensors (not shown in this figure), and may process and transmit the results to the control unit. The sensor package may likewise receive command inputs over the wireless link from the control unit.

A sensor package of this sort, with sensing and wireless communication capabilities, may be attached to all sorts of slung loads that are carried below an aircraft—not only cabins of the sort described hereinabove—in order to give the pilot information about movements of the load (even when thrusters are not available to control the load). Therefore, the term “cabin,” as used in the present patent application and in the claims, is not limited to the sort of rigid, rectangular containers shown in the figures, but rather should be understood broadly to mean any sort of platform or container, whether rigid or flexible, that may be used to raise and lower loads below an aircraft.

In addition to the role of thrusters 42 in guiding cabin 124 to its target, the thrusters may also be used in stabilizing the cabin while the cabin hangs below helicopter 122 during flight. Although longitudinal motion of the cabin (parallel to the direction of flight of the helicopter) is normal and generally acceptable, lateral (side-to-side) motion of the cabin may compromise stability and make flying difficult. Inertial sensors in sensor package 132 may be used during flight to sense lateral movement. The control unit (in the helicopter or in the cabin) may then actuate thrusters 42 to counteract the lateral movement and thus enhance flight stability.

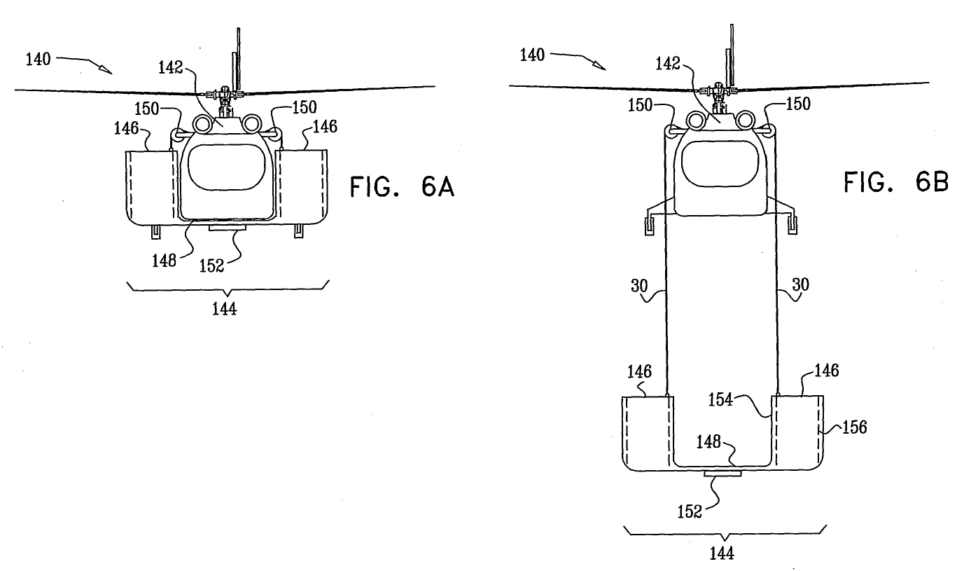

FIGS. 6A and 6B are schematic frontal views of a system 140 for aerial transport, in accordance with a further embodiment of the present invention. In this embodiment, a cabin 144 comprises two compartments 146 joined by a frame 148, and is configured to be fitted to a helicopter 142 so that the compartments are on opposite sides of the fuselage, as shown in FIG. 6A. The width of frame 148 is slightly larger than the width of the helicopter. A clamping mechanism (not shown in these figures) secures the frame to the helicopter, so that the helicopter can take off, fly stably, and land with the cabin in the position shown in FIG. 6A. Inner doors 154 on the inner side of compartments 146 communicate with the side doors (not shown) of the helicopter, so that people and materials may be moved between the helicopter and the compartments while the helicopter is in flight.

As helicopter 142 hovers over the target, cabin 144 is lowered by winches 150 on cables 30, as shown in FIG. 6B. One or more sensors, such as an image sensor 152, are used in guiding the cabin to the target. Cabin 144 may also comprise thrusters and other features, as are shown and described in the preceding embodiments. Once the cabin has reached the target, outer doors 156 on the outer sides of compartments 146 may be opened to allow people and materials to exit and enter the compartments. Although the dual-compartment design of cabin 144 is useful in maintaining balance and stability of helicopter 142, a lightweight cabin that is lowered and raised on one side of the helicopter may alternatively be used.

Cabins of other shapes, sizes and configurations may be used in the manner described above and are considered to be within the scope of the present invention. It will thus be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. Apparatus for aerial transport, comprising:
a cabin for containing a load;
one or more cables, attached so as to suspend the cabin below a hovering aircraft;
an elevator mechanism, which is coupled to raise and lower the cabin on the one or more cables;
at least one cabin sensor; and
a control unit, which is coupled to receive an input from the at least one cabin sensor that is indicative of the disposition of the cabin relative to the terrestrial target, and to control the elevator mechanism responsively to the input so as to bring the cabin into a predetermined position relative to the terrestrial target while the aircraft is hovering.

2. The apparatus according to claim 1, wherein the cabin is shaped and sized so as to fit within a recess in a fuselage of the aircraft, and to be lowered out of the recess on the one or more cables.

3. The apparatus according to claim 1, wherein the elevator mechanism comprises a winch for extending and retracting the cables.

4-5. (canceled)

6. The apparatus according to claim 1, and comprising a load sensor, which is coupled to measure a tension in the one or more cables.

7. The apparatus according to claim 1, and comprising a speed sensor, which is coupled to measure a rate of raising or lowering the cabin by the elevator mechanism.

8. The apparatus according to claim 1, wherein the at least one cabin sensor comprises an imaging device, which is disposed so as to capture an image of the terrestrial target, and wherein the control unit is configured to process the image so as to determine the disposition of the cabin relative to the terrestrial target.

9. The apparatus according to claim 8, wherein the imaging device comprises a firsts imaging device disposed on the cabin for capturing a first image of the terrestrial target, and wherein the apparatus comprises a second imaging device disposed on the cabin for capturing a second image of the aircraft.

10-13. (canceled)

14. The apparatus according to claim 1, wherein the at least one cabin sensor comprises an inertial sensor, wherein the inertial sensor comprises a first inertial sensor fixed to the cabin, and the apparatus comprises a second inertial sensor fixed to the aircraft, and wherein the control unit is operative to detect changes in a first reading provided by the first inertial sensor relative to a second reading provided by the second inertial sensor, and to process the detected changes in order to measure a motion of the cabin relative to the aircraft.

15. (canceled)

16. The apparatus according to claim 1, wherein the at least one cabin sensor comprises a proximity sensor, which is configured to indicate a distance between the cabin and an object adjacent to the cabin.

17. The apparatus according to claim 1, wherein the at least one cabin sensor comprises at least one satellite-based navigation device, wherein the at least one satellite-based navigation device comprises a plurality of first satellite-based navigation devices fixed to the cabin at different, respective locations, and wherein the apparatus comprises at least one second satellite-based navigation device fixed to the aircraft, and wherein the control unit is coupled to receive and process inputs from the first and second satellite-based navigation devices in order to determine a position and orientation of the cabin relative to the aircraft.

18. (canceled)

19. The apparatus according to claim 1, wherein the at least one cabin sensor comprises a rangefinder.

20. The apparatus according to claim 1, wherein the control unit is configured to control the elevator mechanism responsively to the input so as to bring the cabin into contact with the terrestrial target while the aircraft is hovering.

21. The apparatus according to claim 1, wherein the cabin comprises two compartments, which are configured to fit on opposite, respective sides of fuselage of the aircraft.

22. (canceled)

23. The apparatus according to claim 1, and comprising one or more thrusters, which are fixed to the cabin and configured to exert a force in a direction transverse to the one or more cables, so as to maneuver the cabin relative to the aircraft, wherein the control unit is coupled to control the one or more thrusters responsively to the input from the at least one cabin sensor.

24. The apparatus according to claim 23, wherein the at least one cabin sensor is configured to sense a force exerted on the cabin by a wind, and wherein the control unit is configured to actuate at least one of the thrusters so as to counteract the force.

25. The apparatus according to claim 23, wherein the cabin is configured to hang below the aircraft during longitudinal flight of the aircraft, and wherein the one or more thrusters are operative during the longitudinal flight to exert the force so as to stabilize the cabin against lateral movement.

26. (canceled)

27. The apparatus according to claim 23, wherein the terrestrial target is located on a vertical surface, and wherein the control unit is configured to cause the elevator mechanism and thrusters to bring the cabin into proximity with the vertical surface without contacting a horizontal surface beneath the vertical surface.

28. The apparatus according to claim 23, wherein the terrestrial target is located on a horizontal surface, and wherein the control unit is configured to cause the elevator mechanism to lower the cabin onto the terrestrial target while the aircraft hovers above the terrestrial target.

29-30. (canceled)

31. Apparatus for aerial transport, comprising:
an aircraft, which is capable of hovering;
a cabin for containing a load;
one or more cables, attached so as to suspend the cabin below the aircraft while the aircraft hovers;
an elevator mechanism, which is coupled to raise and lower the cabin on the one or more cables;
one or more thrusters, which are fixed to the cabin and configured to exert a force in a direction transverse to the one or more cables, so as to maneuver the cabin relative to the aircraft;
at least one cabin sensor; and
a control unit, which is coupled to receive an input from the at least one cabin sensor that is indicative of the disposition of the cabin relative to the terrestrial target, and to control the elevator mechanism and the thrusters responsively to the input so as to bring the cabin into contact with the terrestrial target while the aircraft is hovering.

32-33. (canceled)

34. A computer-implemented method for aerial transport, comprising:
lowering a cabin, for containing a load, from a hovering aircraft toward a terrestrial target using one or more cables attached to the aircraft;
sensing a disposition of the cabin relative to the terrestrial target using at least one cabin sensor; and
responsively to an input from the at least one cabin sensor, automatically controlling the lowering of the cabin so as to maneuver the cabin relative to the aircraft and to bring the cabin into a predetermined position relative to the terrestrial target while the aircraft is hovering.

35-60. (canceled)
